(19) United States
(12) Patent Application Publication
(10) Pub. No.: US 2015/0278887 A1
(43) Pub. Date: Oct. 1, 2015

(54) DYNAMICALLY DETERMINING PAYMENT PRICES ASSOCIATED WITH PAYMENT METHODS

(71) Applicant: PAYSTAND, INC., Santa Cruz, CA (US)

(72) Inventor: Jeremy ALMOND, Santa Cruz, CA (US)

(73) Assignee: PAYSTAND, INC., Santa Cruz, CA (US)

(21) Appl. No.: 14/229,267

(22) Filed: Mar. 28, 2014

(51) Int. Cl. G06Q 30/02; G06Q 20/10

(52) U.S. Cl. CPC G06Q 30/0283; G06Q 20/102

(57) ABSTRACT

In a computer-implement method for dynamically determining payment prices associated with payment methods, an online checkout system comprising a balance due is accessed, wherein payment of the balance due is provided by one of the payment methods. Payment prices for the balance due associated with each of the payment methods are dynamically determined.

### BACKGROUND

Typically, merchants are required to pay transaction fees for purchases of the merchant's goods and/or services when the purchases are made via electronic funds transfers. As a result, the merchants receive less money than the actual purchase price of the goods and/or services. Oftentimes, only a single method of payment is provided for the purchase of the goods and/or services when purchased via an online store.

Moreover, transaction fees based on electronic funds transfers are not displayed at the online shopping cart or check out at the time of purchase.

### BRIEF SUMMARY OF EMBODIMENTS

It should be appreciated that embodiments of the present invention can be implemented in numerous ways, including as a process, a system, a device, a method, a computer-implemented method, or a non-transitory computer-readable storage medium.

In one embodiment, a computer-implemented method for dynamically determining payment prices associated with payment methods is provided. The computer-implemented method includes accessing an online checkout system comprising a balance due, wherein payment of the balance due is provided by one of the payment methods. Payment prices for the balance due associated with each of the payment methods are dynamically determined.

In another embodiment, a computer-implemented method for providing a plurality of online payment methods in an online checkout system is provided. The computer-implemented method includes providing a plurality of payment methods for a balance due in the online checkout system. The total payment prices of the balance due associated with each of said plurality of payment methods are dynamically determined, wherein the determined total payment prices are for display in the online checkout system. Also, a difference of the total payment prices associated with each of the plurality of payment methods are dynamically determined, wherein the difference of the total payment prices are for display in the online checkout system.

In a further embodiment, a computer-implemented method for enabling display of an online checkout system with a plurality of payment methods is provided. The computer-implemented method includes enabling display of a plurality of payment methods for a balance due in the online checkout system, and enabling dynamic display of payment prices of the balance due associated with each of said plurality of payment methods.

The advantages of the present invention will become apparent from the following detailed description, taken in conjunction with the accompanying drawings, illustrating by way of example the principles of the invention.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is a block diagram that illustrates an embodiment of an online shopping and payment system.

FIG. 2 is a block diagram that illustrates a screenshot of an embodiment of an online checkout system.

FIG. 3 depicts a flow diagram for a method for determining payment prices associated with payment methods, according to various embodiments.

FIG. 4 depicts a flow diagram for a method for providing a plurality of online payment methods in an online checkout system, according to various embodiments.

FIG. 5 depicts a flow diagram for a method for enabling display of an online checkout system with a plurality of payment methods, according to various embodiments.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

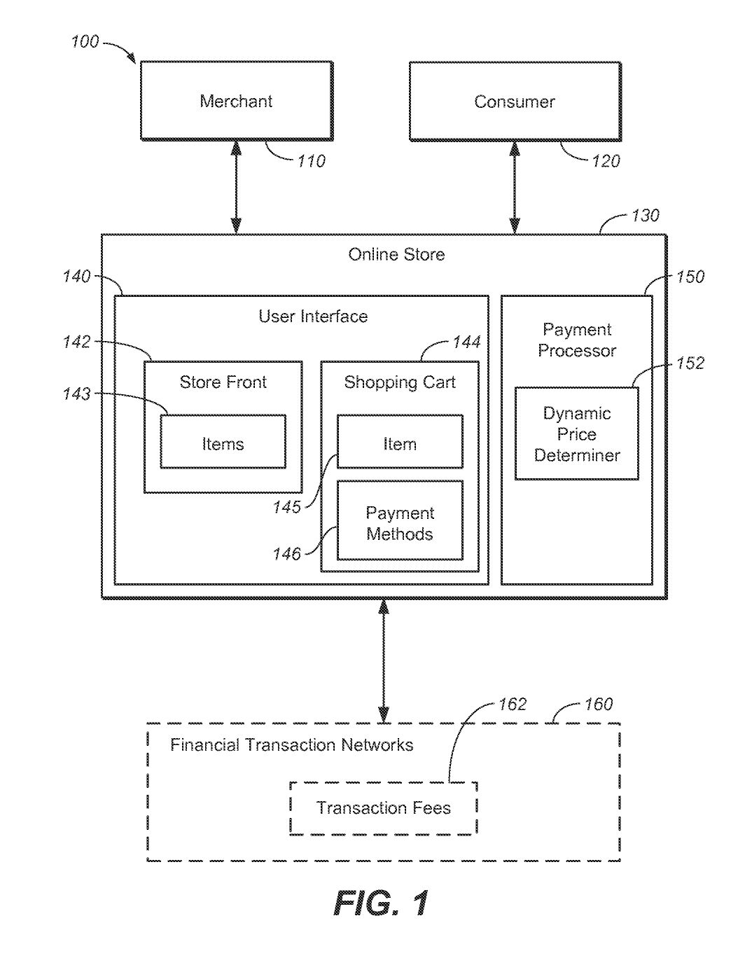

FIG. 1 depicts a block diagram that illustrates an online shopping and payment system 100, (also referred herein as “system”), that includes, among other things, online store 130 that is communicatively coupled to a plurality of financial transaction networks 160.

Online store 130 is an electronic commerce (eCommerce) software platform. In one embodiment, online store 130 allows consumers to buy items from a merchant or seller over the Internet, for example, via a web browser. Moreover, online store 130 facilitates in processing the payment of the items.

The term “items” used herein, may be, but are not limited, goods, services, bill payments, donations, invoices, and the like.

Online store 130 may be integrated or embedded on various websites and/or social networks (e.g., Facebook®, Twitter®, Tumblr®, etc.). Accordingly, the items are offered for sale by merchant 110 and may be purchased by consumer 120 through such websites and/or social networks.

Additionally, online store 130 may be accessed via various computing devices. For example, merchant 110 or consumer 120 may access online store 130 via a desktop computer, tablet (e.g., iPad®), smart phone (e.g., iPhone®) and the like.

Online store 130 includes user interface 140. User interface 140 includes, among other things, store front 142 and checkout system 144. In one embodiment, checkout system 144 is an online shopping cart.

Store front 142 enables merchant 110 to provide items 143 for sale such that the items may be viewed online by various parties. For example, merchant 110 lists various goods and services for sale in store front 142. The merchant may provide a photo and/or description of items 143.

Store front 142 also enables various parties (e.g., consumer 120) to peruse store front 142 and items 143 for potential purchase of one or more of items 143. For example, merchant 110 provides shoes for sale in store front 142. Consumer 120, who is interested in purchasing shoes, peruses the shoes which are displayed on a display screen of a computing device.

Any of items 143 may be selected for potential purchase. Once selected, by consumer 120 an item is selected, the item is then placed in checkout system 144 (e.g., shopping cart) of consumer 120. For example, item 145 (e.g., shoes), which is one of items 143, is selected by consumer 120 in store front 142 and placed in checkout system 144 for subsequent purchase.

Items 145 placed in checkout system 144 may be immediately available for purchase by consumer 120.

Checkout system 144 also includes payment methods 146. Payment methods 146 are any electronic payment methods (e.g., electronic funds transfers (EFTs)) for online transactions. Payment methods 146 via online store 130 can be but are not limited to, credit card, electronic check (e.g., direct debit payment), and electronic currency (e.g., Bitcoin).

In one embodiment, payment methods 146 also include a non-electronic payment method. For example, the purchase of an item or payment of a bill/invoice through online store 130 may be provided, in part, by cash payments. In such an example, a user selects to make a payment via cash and subsequently makes the payment at a cash payment center.

Checkout system 144 includes balance due 147. Balance due 147, in one embodiment, is the subtotal of the items 145 in checkout system 144 prior to purchase. The total payment price of items 145 may include additional fees (e.g., transaction fees, shipping), which will be described in further detail below.

In various embodiments, online store 130 is utilized primarily for payment processing. For example, checkout system 144 is utilized for direct payment of a balance due for bills, donations, invoices, etc.

More specifically, checkout system 144 includes balance due 147 that is not associated with items that a merchant has selected from an online store front and automatically placed in checkout system 144. For instance, balance due 147 may be a subtotal for bills/invoices (e.g., electricity bill, water bill, etc.) to be paid by the user (e.g., consumer 120). A total payment price of the direct payment may include additional fees (e.g., transaction fees), which will be described in further detail below.

Online store 130 is communicatively coupled with various financial transaction networks 160 associated with each type of payment method. In general, each of the financial transaction networks 160 (e.g., financial transaction network for credit cards, electronic checks and electronic currency) drive the electronic exchange or transfer of money from a consumer's account to a merchant's account. In various embodiments, the financial transaction networks may provide the transfer of money within a single financial institution or across multiple financial institutions, which will be described in further detail below. The financial transaction networks, in some embodiments, determine if a consumer credit or debit card is valid and if there are sufficient funds for payments of a balance due. Moreover, financial institutions provide the communication such that money is routed between a consumer's account and a merchant's account.

In one embodiment, if a balance due in the checkout system is paid via a credit card payment method, then payment processor 150 transmits the request to purchase item 145 to a credit card financial transaction network. The credit card financial transaction network then directs the transfer of money from a financial account of consumer 120 to a financial account of merchant 110.

The credit card financial transaction network may include one or more financial institutions (e.g., First Data™, Chase Paymentech™) that provide electronic payment processing.

The credit card financial transaction network, in one embodiment, includes a credit card network (e.g., Visa™ or Mastercard™), which may also be considered a financial institution, that facilitates in the transfer of electronic funds. More specifically, the credit card networks communicate with the banks of merchant and consumer, to establish a trust between the merchant and consumer.

In another embodiment, if a balance due in the checkout system is paid via an electronic check payment method, then payment processor 150 transmits the request to pay for balance due 147 to an electronic check financial transaction network. The electronic check financial transaction network then directs the transfer of money from a financial account of consumer 120 to a financial account of merchant 110.

The electronic check financial transaction network is similar to the credit card financial transaction network, as described above. However, in one embodiment, the financial transaction goes through an Automated Clearing House (ACH) rather than a credit card network. In general, the ACH is a batch processing, store-and-forward system that provides for interbank clearing of electronic payments.

In a further embodiment, if a balance due in the checkout system is paid via an electronic currency payment method, then payment processor 150 transmits the request to pay for balance due 147 to an electronic currency financial transaction network. The electronic currency financial transaction network then directs the transfer of money from a financial account of consumer 120 to a financial account of merchant 110.

In various embodiments, the electronic currency is decentralized digital currency (e.g., Bitcoin) that enables instant payments between any parties. The electronic or digital currency may use peer-to-peer technology to operate with no central authority: managing transactions and issuing money are carried out collectively by the network (e.g., electronic currency financial transaction network). The network may include various nodes. The nodes in the network are based on peer-to-peer networking, digital signatures and cryptographic proof to make and verify transactions. Nodes broadcast transactions to the network, wherein the network publicly records the transactions, called the blockchain, after validating the transactions with a proof-of-work system.

In some instances, financial transaction networks 160 include transaction or processing fees for the payment of balance due 147 which may be the transfer of money between merchant 110 and consumer 120.

A credit card financial transaction network may include an interchange fee that is set by the credit card networks. In particular, the interchange fee is paid between the banks of the consumer and merchant for a credit card based transaction. The interchange rate may be a fixed or variable rate (e.g., 0.09%) for each credit card transaction. In such an example, for a 0.09% interchange rate, a credit card purchase of $100 would incur a $0.09 interchange fee.

A credit card financial transaction network may also include a processing fee provided by the financial institutions (e.g., First Data™, Chase Paymentech™). The processing rate may be fixed or variable (e.g., 2.9%). Moreover, the processing rate may be negotiated, for example, by online store 130. In such an example, for a 2.9% processing rate, a credit card purchase of $100 would incur a $2.90 processing fee.

An electronic check financial transaction network may also include a transaction or processing fee provided by a financial institution (e.g., First Data™, Chase Paymentech™). The processing fee may be a fixed fee (e.g., $0.25). In such an example, a $0.25 fee is incurred for each electronic check transaction of any amount. It is noted that the transaction fee for using an electronic check is less than the transaction fee for using a credit card.

In some instances, financial transaction networks 160 do not include any transaction or processing fees for the payment of balance due 147. For example, an electronic currency financial transaction network does not include a transaction fee because the digital currency utilizes peer-to-peer technology having no central authority to transfer the currency between parties.

In conventional, ecommerce systems, the transaction fees are paid for by the merchant. For example, if a merchant sells an item for $100 and there is a $5 transaction fee assessed to the transaction by the financial transaction network, the merchant is responsible to pay the $5 transaction fee and the merchant will have $95 transferred to the merchant's account.

In contrast, if a merchant sells an item for $100 through online store 130 and there is a $5 transaction fee assessed to the transaction by the financial transaction network, the consumer is responsible to pay $5 transaction. For example, the consumer will pay $105 for the purchase of the $100 item and the merchant will have $100 transferred to the merchant's account.

Dynamic price determiner 152 of payment processor 150 dynamically determines the price of an item, for the consumer, with respect to payment methods 146. More specifically, dynamic price determiner 152 determines the transaction fees for the various payment methods (e.g., credit card or electronic check payment method) associated with balance due 147, such as, a balance due for an items 145 in checkout system 144. If transaction fees are determined for a payment method by the dynamic price determiner, the determined transaction fees are then passed onto the consumer as part of the financial transaction within the respective financial transaction network.

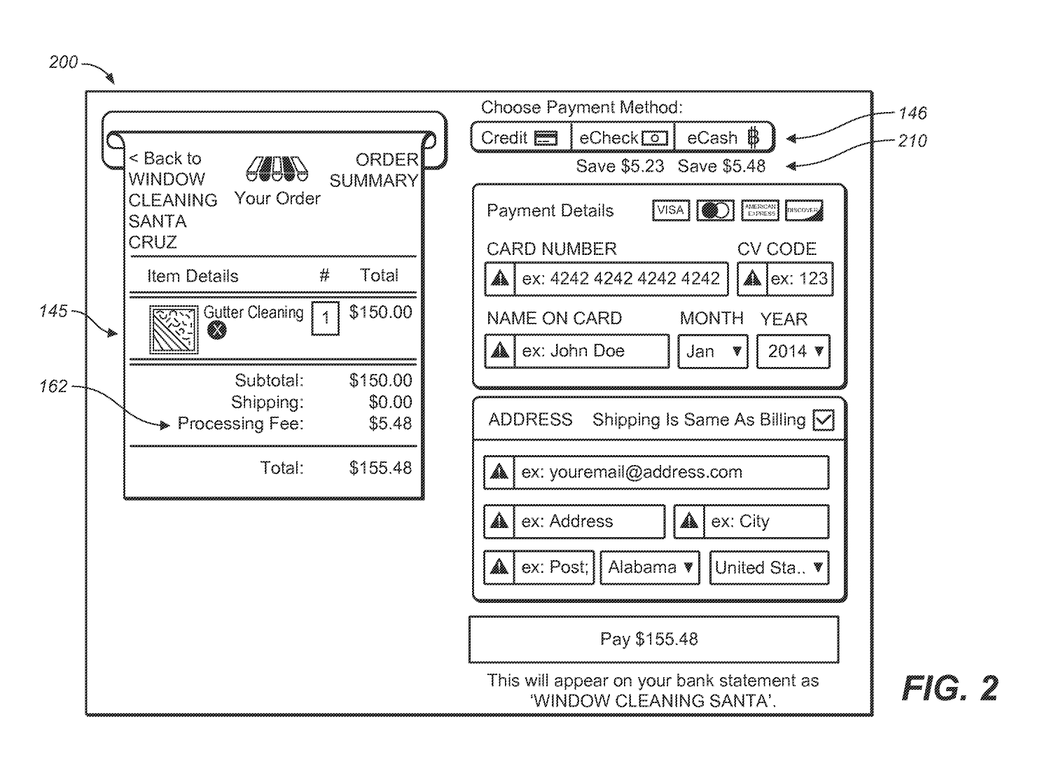

FIG. 2 depicts a screenshot of an embodiment of checkout system 200 that is displayed on a computing device, such as a consumer's computing device. Checkout system 200 is similar to checkout system 144 described herein.

Checkout system 200 includes item 145. As depicted, item 145 is a gutter cleaning service offered at a price of $150.

Checkout system 200 includes payment methods 146. As depicted, the payment methods may include credit card (i.e., “Credit”), electronic check (i.e., “eCheck”), and electronic currency (i.e., “eCash”). It is noted that FIG. 2 depicts the “Credit” as the selected method of payment. In various embodiments, electronic check or electronic currency methods of payment may be selected. It should be appreciated that payment methods 146 may be any payment method that enables for payment of a balance due, such as a cash payment.

In one embodiment, the merchant controls which of the payment methods are utilized in checkout system 200 for payment of the balance due. For example, if a merchant wants payment by credit card and echeck, then the merchant selects the two payment option such that they are the only two payment options provided to the consumer. In various embodiments, any combination of the various payment methods may be selected to be utilized in checkout system 200.

By selecting the credit card payment method, transaction fee 162 (or processing fee) of $5.48 is assessed by the credit card financial transaction network. The transaction fee for the purchase of item 145 is paid for by the consumer (rather than the merchant). The total price (or balance due), to the consumer, for the purchase of the gutter cleaning service is $155.48. Accordingly, the merchant is not responsible the transaction fee and subsequently receives the entire $150 for the purchase of the gutter cleaning service.

In one embodiment, dynamic price determiner 152 dynamically determines the balance due of items that are placed in the checkout system. For example, item 145 is placed in the checkout system, dynamic price determiner 152 automatically determines, in real-time, if there are any transaction fees for purchasing item 145 for any of the payment methods.

If any transaction fees are determined, then the total price (or balance due) of the item is the listing price of the item plus any transaction fees. For example, FIG. 2 depicts the total cost of the gutter cleaning service to be $150 plus $5.48 for transaction fees for a total cost of $155.48 to the consumer.

Additionally, checkout system 200 includes the difference of the transaction fees 210 for each method of payment with respect to items in the shopping cart. Dynamic price determiner 152 determines the difference in the transaction fees for each method of payment for an item. In other words, dynamic price determiner 152 determines how much a consumer will save various payment methods (e.g., electronic check or electronic cash) with respect to one of the payment methods (e.g., credit card). For example, referring to FIG. 2, if a consumer selects the credit card payment method, transaction fee of the electronic cash is $5.23 less than the transaction fee of the credit card, and the transaction fee of the electronic currency is $5.48 less than the transaction fee of the credit card. By showing the cost savings for various payment methods to the consumer, the consumer is able to make a more insightful decision as to which payment method to utilize for the purchase of items via online store 130.

### Example Methods of Operation

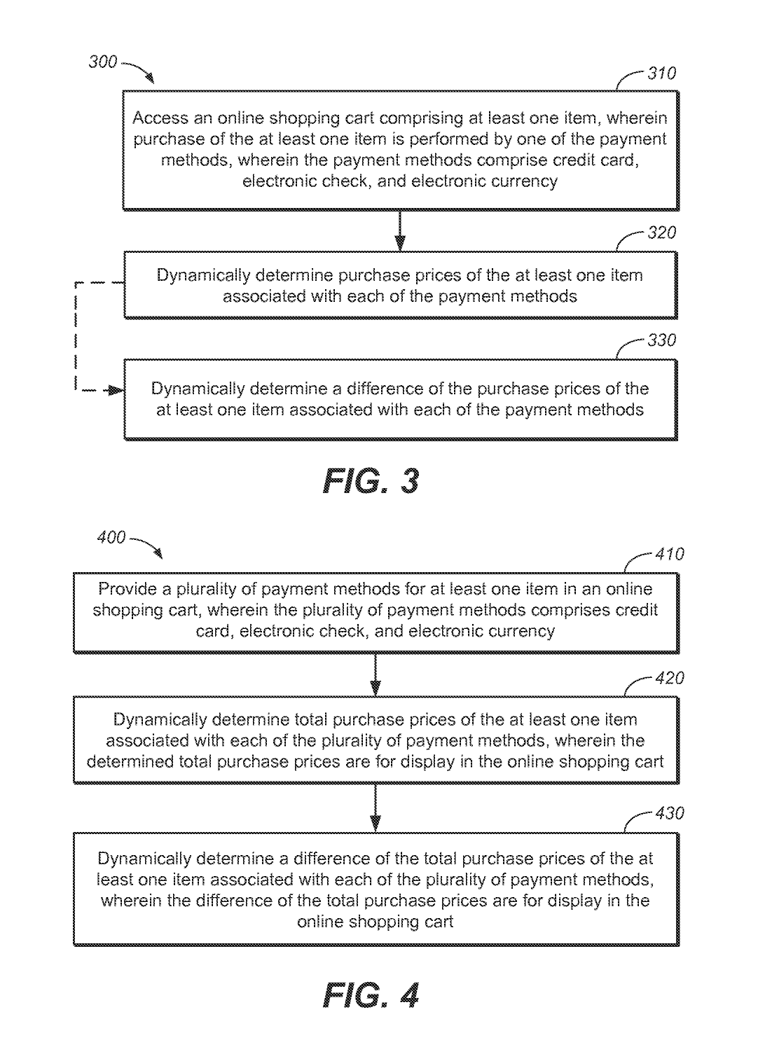

The following discussion sets forth in detail the operation of some example methods of operation of embodiments. With reference to FIGS. 3, 4 and 5, flow diagrams 300, 400 and 500 illustrate example procedures used by various embodiments. Flow diagrams 300, 400 and 500 include some procedures that, in various embodiments, are carried out by a processor under the control of computer-readable and computer-executable instructions. In this fashion, procedures described herein and in conjunction with flow diagrams 300, 400 and 500 are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments and/or cloud environments. The computer-readable and computer-executable instructions, which reside on tangible computer readable storage media, are used to control or operate in conjunction with, for example, one or some combination of processors of the computer environments and/or cloud environment. It is appreciated that the processor(s) may be physical or virtual or some combination (it should also be appreciated that a virtual processor is implemented on physical hardware). Although specific procedures are disclosed in flow diagrams 300, 400 and 500, such procedures are examples. That is, embodiments are well suited to performing various other procedures or variations of the procedures recited in flow diagrams 300, 400 and 500. Likewise, in some embodiments, the procedures in flow diagrams 300, 400 and 500 may be performed in an order different than presented and/or not all of the procedures described in one or more of these flow diagrams may be performed. It is further appreciated that procedures described in flow diagrams 300, 400 and 500 may be implemented in hardware, or a combination of hardware with firmware and/or software.

FIG. 3 depicts a process flow diagram 300 for a method for dynamically determining payment prices associated with payment methods, according to various embodiments.

At 310, an online checkout system comprising a balance due is accessed, wherein payment of the balance due is provided by one of the payment methods.

For example, checkout system 144 including balance due 147 is accessed, for example, by payment processor 150 of online store 130. It should be appreciated that the balance due may be associated with items 145 selected from storefront 142 or may be associated with a direct payment for bills, invoices, donations, etc. It is noted that a consumer selects a payment method to make a payment for the balance due. The payment methods can include, but are not limited to, a credit card, electronic check, electronic currency, and cash.

At 320, payment prices for the balance due associated with each of the payment methods are dynamically determined. For example, dynamic price determiner 152 dynamically determines the purchase prices for balance due 147 including any transaction fees for each of the payment methods. More specifically, for example, dynamic price determiner 152 dynamically determines (1) a first total payment price for purchase of item 145 with a credit card, (2) a second total payment price for purchase of item 145 with an electronic check (e.g., lower than the credit card price), and (3) a third total payment price for purchase of item 145 with electronic currency (e.g., lower than the electronic check price). It is noted that dynamic price determiner 152 dynamically determines the payment price of item 145 for each payment method prior to actual payment of the item by the consumer.

At 330, in one embodiment, a difference of the payment prices of payment due associated with each of the payment methods is dynamically determined. For example, dynamic price determiner 152 dynamically determines the difference of payment prices of item 145 associated with each of the payment methods. For example, dynamic price determiner 152 dynamically determines (1) the difference in payment price (or the amount a consumer saves) between a credit card purchase and an electronic check purchase, and (2) the difference in payment price between a credit card purchase and an electronic currency purchase. It is noted that dynamic price determiner 152 dynamically determines difference of the payment prices prior to actual payment of the item by the consumer (or customer).

It is noted that any of the procedures, stated above, regarding flow diagram 300 may be implemented in hardware, or a combination of hardware with firmware and/or software. For example, any of the procedures may be implemented by a processor(s) of a webserver(s) that hosts online store 130.

FIG. 4 depicts a process flow diagram 400 for a method for providing a plurality of online payment methods in an online checkout system, according to various embodiments.

At 410, a plurality of payment methods are provided for a balance due in an online checkout system. For example, checkout system 144 includes various payment methods 146 for the purchase of item 145. The various payment methods may include credit card, electronic check, electronic currency, and cash.

At 420, the total payment prices of the balance due associated with each of the plurality of payment methods are dynamically determined, wherein the determined total payment prices are for display in the checkout system. For example, dynamic price determiner 152 dynamically determines the total payment price of item 145 (or direct billing for a bill) for each payment method, wherein the total payment of item 145 for each payment method may include transaction fees for the respective payment method. In such an example, dynamic price determiner 152 dynamically determines (1) a first total payment price for payment of item 145 with a credit card, (2) a second total payment price for payment of item 145 with an electronic check (e.g., lower than the credit card price), and (3) a third total payment price for payment of item 145 with electronic currency (e.g., lower than the electronic check price). It is noted that dynamic price determiner 152 dynamically determines the payment price of item 145 for each payment method prior to actual payment of the item by the customer.

At 430, a difference of the total purchase prices of the balance due associated with each of the plurality of payment methods is dynamically determined, wherein the difference of the total payment prices are for display in the online shopping cart. For example, dynamic price determiner 152 dynamically determines the difference of payment prices of item 145 associated with each of the payment methods. For example, dynamic price determiner 152 dynamically determines (1) the difference in payment price (or the amount a consumer saves) between a credit card purchase and an electronic check purchase, and (2) the difference in the payment price between a credit card purchase and an electronic currency purchase. It is noted that dynamic price determiner 152 dynamically determines difference of the payment prices prior to actual payment by the customer.

It is noted that any of the procedures, stated above, regarding flow diagram 400 may be implemented in hardware, or a combination of hardware with firmware and/or software. For example, any of the procedures may be implemented by a processor(s) of a webserver(s) that hosts online store 130.

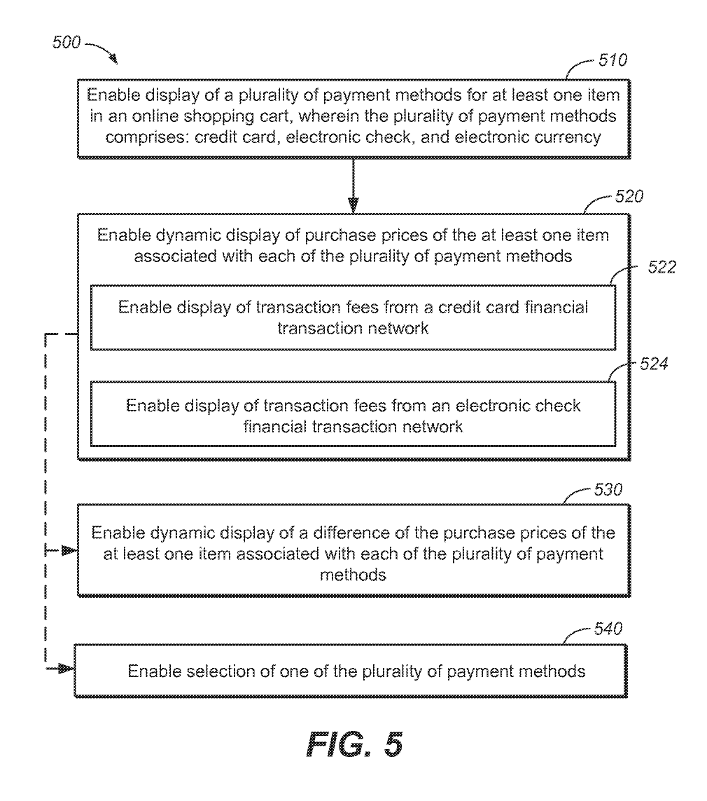

FIG. 5 depicts a process flow diagram 500 for a method for enabling display of an online checkout system with a plurality of payment methods, according to various embodiments.

At 510, display of a plurality of payment methods for a balanced due in an online checkout system is enabled. For example, online store 130 provides instructions or computer code such that payment methods 146 for purchasing item 145 are displayed in checkout system 200 (which is displayed on a consumer's computing device).

At 520, dynamic display of payment prices of the balance due associated with each of the plurality of payment methods is enabled. For example, online store 130 provides instructions or computer code such that payment prices of the balance due associated with each of the plurality of payment methods are displayed in checkout system 200.

At 522, in one embodiment, display of transaction fees from a credit card financial transaction network is enabled. For example, online store 130 provides instructions or computer code such that transaction fees 162 from a credit card financial transaction network are displayed in checkout system 200.

At 524, in another embodiment, enable display of transaction fees from an electronic check financial transaction network. For example, online store 130 provides instructions or computer code such that transaction fees 162 from an electronic check financial transaction network are displayed in checkout system 200.

At 530, enable dynamic display of a difference of the payment prices of the balance due associated with each of the plurality of payment methods. For example, online store 130 provides instructions or computer code such that a difference of the payment prices of the balance due associated with each of the plurality of payment methods are displayed in checkout system 200.

At 540, enable selection of one of said plurality of payment methods. For example, online store 130 provides instructions or computer code such that a selection of one of payment methods 146 by a consumer is enabled in checkout system 200.

It is noted that any of the procedures, stated above, regarding flow diagram 500 may be implemented in hardware, or a combination of hardware with firmware and/or software. For example, any of the procedures may be implemented by a processor(s) of a webserver(s) that hosts online store 130.

Example embodiments of the subject matter are thus described. Although various embodiments of the have been described in a language specific to structural features and/or methodological acts, it is to be understood that the appended claims are not necessarily limited to the specific features or acts described above. Rather, the specific features and acts described above are disclosed as example forms of implementing the claims and their equivalents. Moreover, various embodiments described herein may be implemented alone and/or in combination with one another.

1. A computer-implement method for dynamically determining payment prices associated with payment methods, comprising:
accessing an online checkout system comprising a balance due, wherein payment of said balance due is provided by one of said payment methods; and
dynamically determining payment prices for said balance due associated with each of said payment methods.

2. The computer-implemented method of claim 1, comprising:
dynamically determining a difference of said payment prices of said balance due associated with each of said payment methods.

3. The computer-implemented method of claim 1, wherein a payment price of said balance due comprises a transaction fee.

4. The computer-implemented method of claim 1, wherein said payment methods comprise: credit card, electronic check and electronic currency.

5. The computer-implemented method of claim 1, wherein a payment price of said balance due does not comprise a transaction fee.

6. The computer-implemented method of claim 1, wherein said one of said payment methods is selected by a consumer.

7. The computer-implemented method of claim 1, wherein any transaction fees in said determined payment prices are paid by a consumer.

8. The computer-implemented method of claim 1, wherein any transaction fees in said determined payment prices are not paid by a merchant.

9. A computer-implemented method for providing a plurality of online payment methods in an online checkout system, comprising:
providing a plurality of payment methods for a balance due in said online checkout system;
dynamically determining total payment prices of said balance due associated with each of said plurality of payment methods, wherein said determined total payment prices are for display in said online checkout system; and
dynamically determining a difference of said total payment prices associated with each of said plurality of payment methods, wherein said difference of said total payment prices are for display in said checkout system.

10. The computer-implemented method of claim 9, wherein a total payment price associated with a credit card payment method comprises:
a transaction fee from a credit card financial transaction network.

11. The computer-implemented method of claim 9, wherein a total payment price associated with an electronic check payment method comprises:
a transaction fee from an electronic check financial transaction network.

12. The computer-implemented method of claim 9, wherein a total payment price associated with an electronic currency payment method does not comprise transaction fees.

13. The computer-implemented method of claim 9, wherein one of said plurality of payment methods is selected by a consumer.

14. The computer-implemented method of claim 9, wherein a transaction fee in said determined total payment prices is paid by a consumer.

15. The computer-implemented method of claim 9, wherein a transaction fee in said determined total payment prices is not paid by a merchant.

16. A computer-implemented method for enabling display of an online checkout system with a plurality of payment methods, comprising:
enabling display of a plurality of payment methods for a balance due in said online checkout system; and
enabling dynamic display of payment prices of said balance due associated with each of said plurality of payment methods.

17. The computer-implemented method of claim 16, comprising:
enabling dynamic display of a difference of said payment prices associated with each of said plurality of payment methods.

18. The computer-implemented method of claim 16, comprising:
enabling selection of one of said plurality of payment methods.

19. The computer-implemented method of claim 16, wherein said enabling dynamic display of purchase prices, further comprises:
enabling display of transaction fees from a credit card financial transaction network.

20. The computer-implemented method of claim 16, wherein said enabling dynamic display of purchase prices, further comprises:
enabling display of transaction fees from an electronic check financial transaction network.
